(19) United States
(12) Patent Application Publication
(10) Pub. No.: US 2025/0385740 A1
(43) Pub. Date: Dec. 18, 2025

(54) OPTICAL RECEIVER AND OPTICAL RECEIVING METHOD

(71) Applicant: Fujitsu Limited, Kawasaki-shi (JP)

(72) Inventors: Yoshitaka NOMURA, Shinagawa (JP); Hisao NAKASHIMA, Kawasaki (JP); Yasutaka KANAYAMA, Inagi (JP); Kazuhiko HATAE, Kawasaki (JP)

(73) Assignee: Fujitsu Limited, Kawasaki-shi (JP)

(21) Appl. No.: 19/229,222

(22) Filed: Jun. 5, 2025

(30) Foreign Application Priority Data
Jun. 13, 2024 (JP) 2024-096114

(51) Int. Cl. H04B 10/61

(52) U.S. Cl. CPC H04B 10/6165; H04B 10/612; H04B 10/613

(57) ABSTRACT

An optical receiver includes a receiver to receive an optical signal that includes a plurality of data symbols and pilot symbols periodically inserted between the plurality of data symbols and that is modulated based on a multi-level modulation method, a first angle calculator to calculate a first phase angle to be used for calculating an initial value when compensating for an optical frequency offset, based on the pilot symbols, a second angle calculator configured to calculate a second phase angle of the plurality of data symbols based on a data symbol adjacent to the pilot symbol, an estimator to estimate an amount of the optical frequency offset based on a differential phase angle between the first phase angle and the second phase angle and amplitude of the data symbol, and a compensator to compensate for the optical frequency offset based on the amount of the optical frequency offset.

### CROSS-REFERENCE TO RELATED APPLICATION

This application is based upon and claims the benefit of priority of the prior Japanese Patent Application No. 2024-096114, filed on Jun. 13, 2024, the entire contents of which are incorporated herein by reference.

### FIELD

A certain aspect of embodiments described herein relates to an optical receiver and an optical receiving method.

### BACKGROUND

Receivers that use multilevel modulation methods in mobile communications and the like are known (see, for example, Japanese Patent Application Publication No. H10-098500). A known multilevel modulation methods is such as QPSK (Quadrature Phase Shift Keying), 16QAM (Quadrature Amplitude Modulation) or the like (see, for example, US Patent Application Publication No. 2022/0294538 and International Publication No. 2014/187742). In addition, in digital mobile radio systems, compensation for frequency offsets using digital signal processing methods is also known (see, for example, Japanese Patent Application Publication No. H09-093302).

### SUMMARY

According to an aspect of the present invention, there is provided an optical receiver including: a receiver configured to receive an optical signal that includes a plurality of data symbols and pilot symbols periodically inserted between the plurality of data symbols and that is modulated based on a multi-level modulation method; a first angle calculator configured to calculate a first phase angle to be used for calculating an initial value when compensating for an optical frequency offset, based on the pilot symbols; a second angle calculator configured to calculate a second phase angle of the plurality of data symbols based on a data symbol adjacent to the pilot symbol among the plurality of data symbols; an estimator configured to estimate an amount of the optical frequency offset based on a differential phase angle between the first phase angle and the second phase angle and amplitude of the data symbol; and a compensator configured to compensate for the optical frequency offset based on the amount of the optical frequency offset.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is an example of an optical transmission system;

FIG. 2 is an example of an optical signal;

FIG. 3 is a block diagram illustrating an example of a hardware configuration of an optical transmitter;

FIG. 4 is a block diagram illustrating an example of a hardware configuration of an optical receiver;

FIG. 5 is a block diagram illustrating an example of a functional configuration of an RxDSP;

FIG. 6 is a block diagram illustrating an example of a functional configuration of an FOC;

FIG. 7 is an example of a functional configuration of a first calculator;

FIG. 8 is a diagram explaining an example of a phase angle difference before and after quadrupling processing of a phase angle of an n-th pilot symbol modulated by QPSK;

FIG. 9A is an example of a constellation of data symbols modulated by 16QAM;

FIG. 9B is an example of a first constellation;

FIG. 9C is an example of a second constellation;

FIG. 10A is another example of a constellation of data symbols modulated by 16QAM;

FIG. 10B is an example of a third constellation;

FIG. 10C is an example of a fourth constellation;

FIG. 11 is a diagram explaining a phase angle difference and optical frequency offset before and after quadrupling a phase angle of a (n+1)-th data symbol modulated with 16QAM;

FIG. 12 is a diagram explaining an example of a phase angle of a third constellation before and after quadrupling;

FIG. 13 is a diagram explaining an example of a phase angle of a fourth constellation before and after quadrupling;

FIG. 14A is an example of a functional configuration of a first estimator;

FIG. 14B is an example of a functional configuration of a corrector;

FIG. 15 is a flowchart illustrating an example of an operation of a first calculator;

FIG. 16 is another example of a functional configuration of a reference calculator;

FIG. 17 is a diagram explaining an example of a phase angle difference before and after multiplication by −45 degrees for a phase angle of an n-th pilot symbol modulated with QPSK; and

FIG. 18 is a diagram illustrating another example of a phase angle difference before and after four-times processing of a phase angle of an n-th pilot symbol modulated by QPSK.

### DESCRIPTION OF EMBODIMENTS

The above-mentioned frequency offset compensation is not limited to digital mobile radio. For example, frequency offset compensation is also performed as optical frequency offset compensation between an optical transmitter and an optical receiver using a multi-level modulation method. In this case, an initial value of the optical frequency offset is calculated when the optical receiver is started, and the optical frequency offset is compensated based on the calculated initial value.

The initial value of the optical frequency offset may be calculated based on data symbols included in the transmission signal from the optical transmitter. In this case, if the number of data symbols is small, the initial value cannot be calculated accurately, and there is a risk of errors occurring in the initial value.

On the other hand, if a large number of data symbols are used to calculate the initial value, the amount of calculation required to calculate the initial value increases, making it difficult to calculate the initial value quickly. In order to calculate the initial value quickly, it is also possible to use, for example, a parallel arithmetic circuit. However, in this case, the circuit size increases because an arithmetic circuit according to the number of parallel circuits is required. The increase in circuit size increases the electrical power consumption when calculating the initial value of the optical frequency offset.

Below, an embodiment will be explained with reference to the drawings.

### First Embodiment

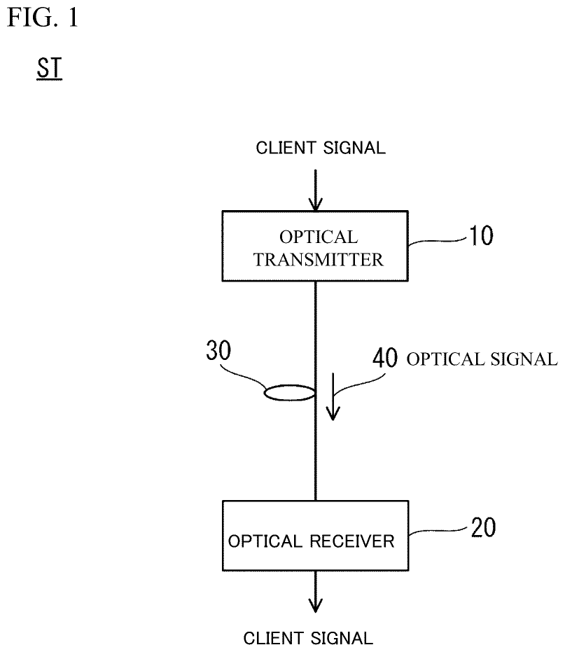

As illustrated in FIG. 1, the optical transmission system ST includes an optical transmitter 10 and an optical receiver 20. The optical transmitter 10 and the optical receiver 20 are connected via an optical transmission path 30. The optical transmission path 30 includes optical fibers and optical repeaters. An example of the optical repeater is such as a ROADM (Reconfigurable. Optical Add/Drop Multiplexer) an ILA (Optical In-Line Amplifier Equipment) or the like. The optical transmitter 10 receives an electrical client signal in digital format from a client network.

The client signal is, for example, an Ethernet (registered trademark) signal. The client signal may be a main signal or a control signal that includes only parameters for adjusting transmission characteristics or the like. The optical transmitter 10 converts the client signal into an optical signal 40 and transmits it to the optical transmission path 30. As a result, the optical signal 40 propagates through the optical transmission path 30. The optical receiver 20 receives the optical signal 40 from the optical transmission path 30. When the optical receiver 20 receives the optical signal 40, the optical receiver 20 converts the optical signal 40 into a client signal and transmits the client signal to the client network.

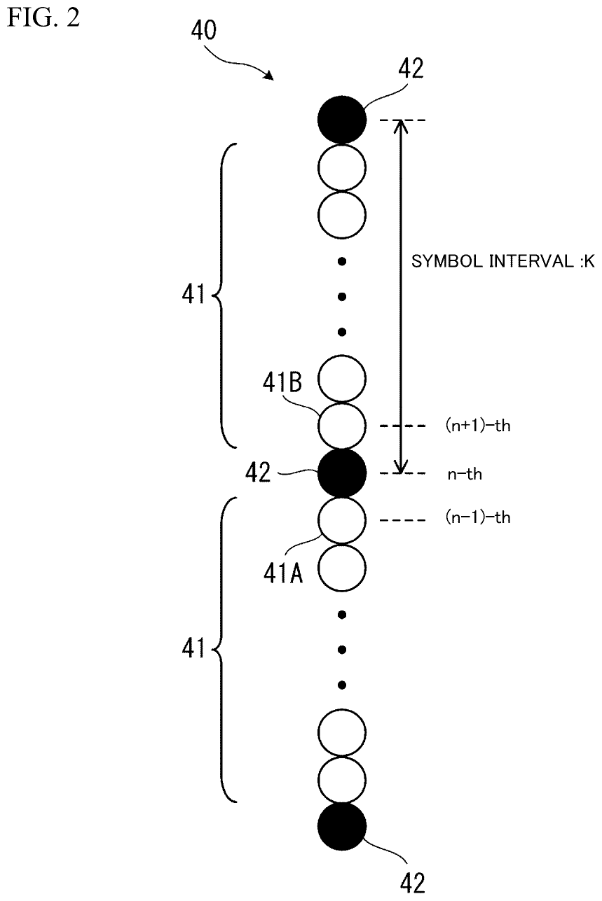

As illustrated in FIG. 2, the optical signal 40 transmitted from the optical transmitter 10 includes, as transmission data, a plurality of data symbols 41 and pilot symbols 42 periodically inserted between the plurality of data symbols 41. The pilot symbols 42 arc inserted between the data symbols 41 at a predetermined symbol interval “K”. For example, the pilot symbols 42 are inserted at symbol intervals “K” such as 32 symbol intervals or 64 symbol intervals.

For example, the data symbols 41 are modulated based on the 16QAM modulation method. The pilot symbols 42 are modulated based on the QPSK modulation method. The data symbols 41 and the pilot symbols 42 are modulated based on different multi-level modulation methods. Therefore, when the pilot symbols are used to calculate the initial value of the optical frequency offset, the amount of calculation required to calculate the initial value can be reduced compared to when the pilot symbols are not used. This makes it possible to reduce the electrical power consumption of the optical receiver 20.

The optical receiver 20 calculates an initial value of the optical frequency offset based on the n-th pilot symbol 42 included in the optical signal 40, the (n−1)-th data symbol 41A adjacent to the front and rear of the n-th pilot symbol 42, and a (n+1)-th data symbol 41B, and compensates for the received signal. Note that “n” is a natural number.

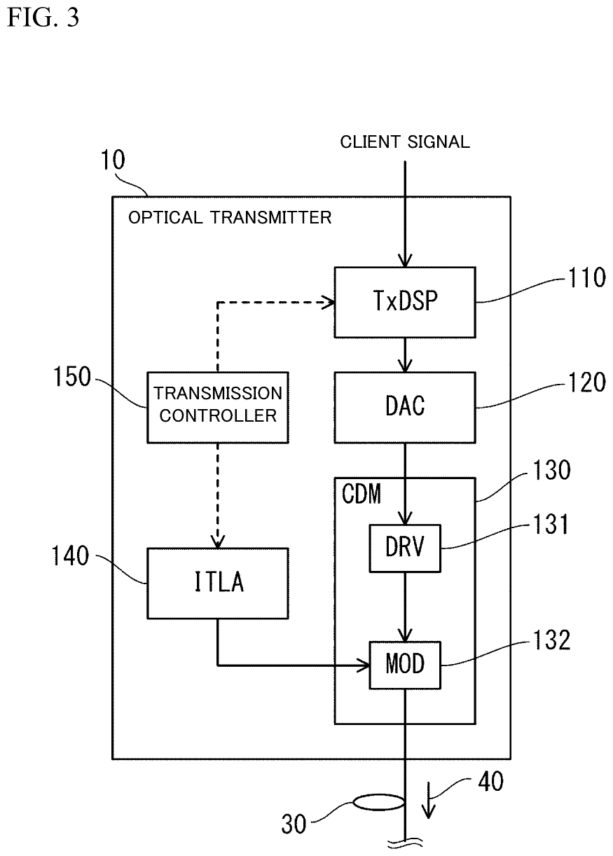

The hardware configuration of the optical transmitter 10 will be described with reference to FIG. 3.

As illustrated in FIG. 3, the optical transmitter 10 has a TxDSP (Tx Digital Signal Processor) 110, a DAC (Digital to Analogue Converter) 120, and a CDM (Coherent Driver Modulator) 130. The TxDSP 110 is a DSP installed in the optical transmitter 10. The CDM 130 includes a driver amplifier (DRV in FIG. 3) 131 and an optical modulator (MOD in FIG. 3) 132. The CDM 130 is an integrated circuit that houses the driver amplifier 131 and the optical modulator 132 in a single package. The optical transmitter 10 also includes an ITLA (Integrable Tunable Laser Assembly) 140 and a transmission controller 150. Although not illustrated, the ITLA 140 includes a transmission light source that outputs transmission light (specifically, laser light).

The TxDSP 110 performs various digital signal processing. For example, the TxDSP 110 accommodates a client signal in a transfer frame and generates a binary data bit string according to the transfer frame. For example, the transfer frame is an OTU (Optical channel Transport Unit) frame. The TxDSP 110 also performs symbol mapping processing based on the modulation method set by the transmission controller 150. Symbol mapping is a process that converts a binary data bit string corresponding to a transmission frame into a string of multiple data symbols.

The TxDSP 110 periodically inserts pilot symbols between data symbols. In addition, the TxDSP 110 compensates in advance for various losses that occur in the optical transmitter 10 for the transmission signal composed of data symbols and pilot symbols. For example, the TxDSP 110 performs skew compensation and bandwidth characteristic compensation. The TxDSP 110 outputs the transmission signal composed of compensated data symbols and pilot symbols to the DAC 120 based on the setting value set by the transmission controller 150.

The DAC 120 converts the transmission signal from digital to analog format and outputs the converted transmission signal to the driver amplifier 131 of the CDM 130. The driver amplifier 131 amplifies the signal amplitude of the transmission signal output from the DAC 120.

The optical modulator 132 modulates the transmission light (specifically, laser light) input from the ITLA 140 based on the signal amplitude amplified by the driver amplifier 131, and generates the optical signal 40 having an arbitrary optical waveform. The optical modulator 132 converts the electrical transmission signal into the optical signal 40 and outputs the optical signal 40 to the optical transmission path 30. In this way, the CDM 130 converts the electrical transmission signal into the optical signal 40 and outputs the optical signal 40 to the optical transmission path 30.

The transmission controller 150 includes a processor and a memory, and controls the operations of the TxDSP 110 and the ITLA 140. For example, the processor is a CPU (Central Processing Unit), and the memory is a volatile memory, RAM (Random Access Memory), and a non-volatile memory, ROM (Read Only Memory). The transmission controller 150 may be an FPGA (Field Programmable Gate Array) or an ASIC (Application Specific Integrated Circuit).

The transmission controller 150 performs various settings on the TxDSP 110 according to instructions from an operation terminal (not shown) and adjusts the frequency of the ITLA 140. The operation terminal may be a PC (Personal Computer) or a smart terminal (for example, a tablet terminal or the like). For example, when a signal type including a symbol rate and a multi-level modulation method is input from the operation terminal to the transmission controller 150, the transmission controller 150 sets the symbol rate, multi-level modulation method or the like in the TxDSP 110.

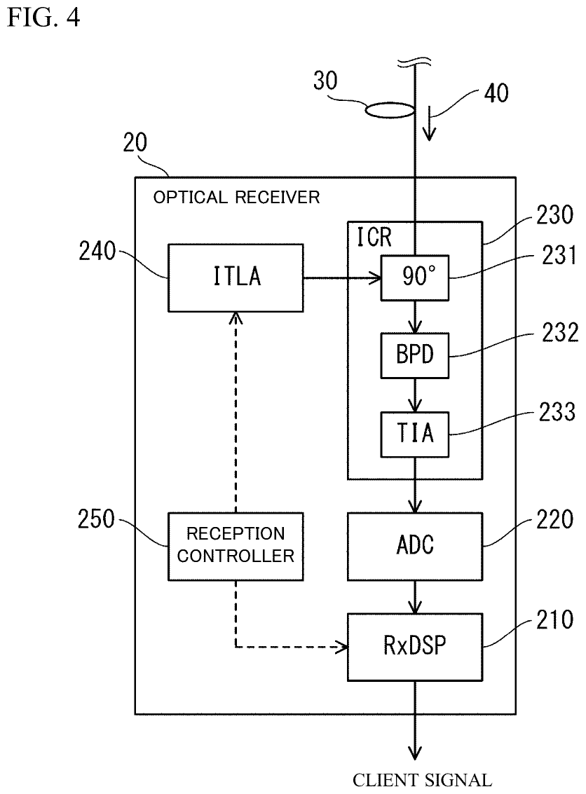

The hardware configuration of the optical receiver 20 will be described with reference to FIG. 4.

As illustrated in FIG. 4, the optical receiver 20 has an RxDSP 210, an ADC (Analogue to Digital Converter) 220, and an ICR (Integrated Coherent Receiver) 230. The RxDSP 210 is a DSP mounted on the optical receiver 20. The ICR 230 has a 90° optical hybrid circuit (simply indicated as 90° in FIG. 4) 231, a BPD (Balanced Photo Diode) 232, and a TIA (Transimpedance Amplifier) 233. The ICR 230 is an integrated circuit that houses the 90° optical hybrid circuit 231, the BPD 232, and the TIA 233 in a single package. The ICR 230 or the 90° optical hybrid circuit 231 is an example of a receiver. The optical receiver 20 also has an ITLA 240 and a reception controller 250. Although not illustrated, the ITLA 240 includes a local light source that outputs local light (specifically, laser light).

The 90° optical hybrid circuit 231 receives the optical signal 40 transmitted from the optical transmitter 10 and propagated through the optical transmission path 30. The 90° optical hybrid circuit 231 receives the optical signal 40 using the local light output from the ITLA 240, and outputs the optical signal 40 to the BPD 232. The BPD 232 converts the optical signal 40 into a current signal, and outputs the current signal to the TIA 233. The TIA 233 converts the current signal output from the BPD 232 into a voltage signal, and amplifies the voltage signal to an amplitude suitable for the ADC 220, and outputs the amplified voltage signal to the ADC 220 as a received data string.

The ICR 230 uses the 90° optical hybrid circuit 231, the BPD 232, and the TIA 233 to convert the input optical signal 40 into an electrical analog-format received data string. The ADC 220 converts the received data string from analog to digital format and outputs the converted optical signal to the RxDSP 210. The RxDSP 210 receives the received data string output from the ADC 220 based on the setting values set in the reception controller 250.

The RxDSP 210 executes various digital signal processing. For example, the RxDSP 210 performs symbol demapping processing on received symbols, which will be described later, based on the setting values of the multi-level modulation method set in the reception controller 250. Specifically, the RxDSP 210 converts the data symbols included in the received symbol string into a binary data bit string and regenerates the transfer frame. After that, the RxDSP 210 extracts the client signal from the transfer frame and transmits the extracted client signal to the client network. Details of the digital signal processing performed by the RxDSP 210 will be described later.

The reception controller 250 performs various settings on the RxDSP 210 according to instructions from the operation terminal, and adjusts the frequency of the ITLA 240. For example, when a signal type including a symbol rate and a multi-level modulation method is input from the operation terminal to the reception controller 250, the reception controller 250 sets the symbol rate, multi-level modulation method, or the like in the RxDSP 210. Note that the hardware configuration of the reception controller 250 is basically the same as the hardware configuration of the transmission controller 150. So, detail description will be omitted.

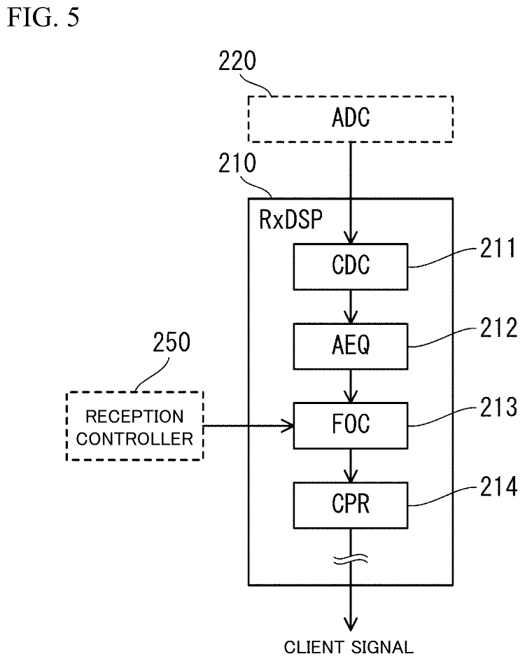

The functional configuration of the RxDSP 210 will be described with reference to FIG. 5.

The RxDSP 210 has a CDC (Chromatic Dispersion Compensation) 211, an AEQ (Adaptive Equalizer) 212, an FOC (Frequency Offset Compensation) 213, and a CPR (Carrier Phase Recovery) 214. Although not illustrated, the RxDSP 210 includes a demodulator that performs symbol demapping and error correction after the CPR 214 and outputs a client signal.

The CDC 211 provides fixed compensation for losses that occur in the optical transmitter 10, the optical receiver 20, and the optical transmission path 30 for the received data string output from the ADC 220. Specifically, the CDC 211 performs chromatic dispersion compensation, skew compensation, and bandwidth characteristic compensation. The AEQ 212 adaptively compensates for the waveform distortion of the optical signal 40 caused by polarization mode dispersion and polarization dependent loss occurring on the optical transmission path 30 for the received data sequence output from the CDC 211. At the same time, the AEQ 212 adjusts the sampling timing of the received data sequence output from the ADC 220, and outputs the symbol-based data sequence as a received symbol sequence to the FOC 213.

The FOC 213 estimates the amount of optical frequency offset representing the amount of optical frequency offset for the received symbol string output from the AEQ 212, and compensates the received symbol string with the estimated amount of optical frequency offset. The optical frequency offset is the difference between the frequency of the transmitted light output by the ITLA 140 of the optical transmitter 10 and the frequency of the local light output by the ITLA 240 of the optical receiver 20. The frequency of the local light is approximately the same as the frequency of the transmitted light, but is not necessarily the same. For this reason, the FOC 213 compensates for the difference between the frequency of the transmitted light and the frequency of the local light, absorbing the difference between the frequency of the transmitted light and the frequency of the local light. The CPR 214 compensates for the fluctuation components of the phase shift caused by phase noise generated in the ITLA 240 or the like.

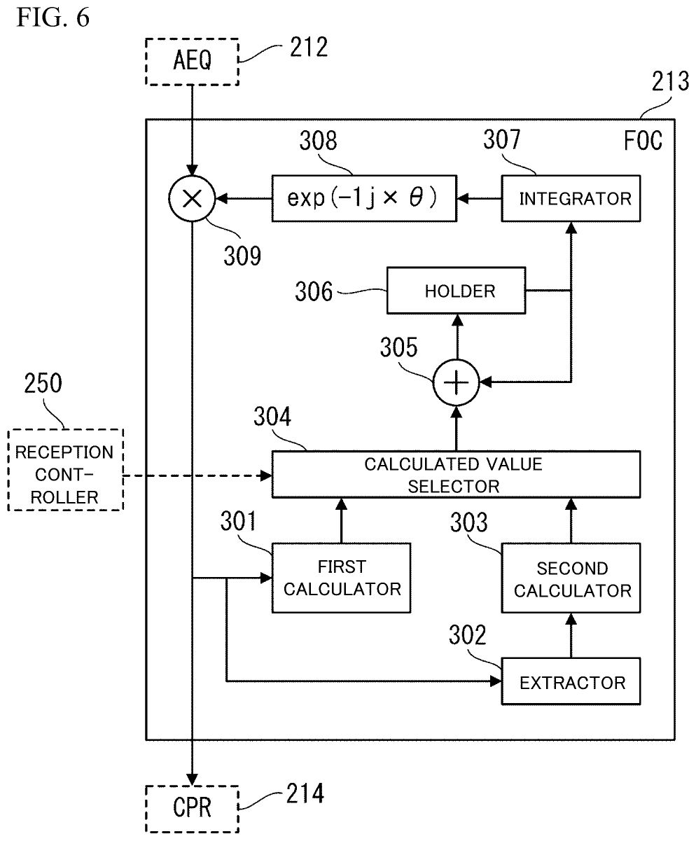

The FOC 213 will be explained with reference to FIG. 6.

The FOC 213 has a first calculator 301, an extractor 302, a second calculator 303, a calculated value selector 304, an adder 305, a holder 306, an integrator 307, and a multiplier 309. The multiplier 309 is an example of a compensator that compensates for the optical frequency offset of the received symbol string. The integrator 307 outputs the optical frequency offset compensation value 308 as an output value to the multiplier 309, as will be described in detail later.

The first calculator 301 extracts a pilot symbol and two adjacent data symbols before and after the pilot symbol from the received symbol string output from the AEQ 212. Specifically, the first calculator 301 receives position information of the pilot symbol 42 in the received symbol string from a synchronizer (not illustrated) provided between the CDC 211 and the AEQ 212 or after the AEQ 212. The first calculator 301 extracts the pilot symbol and the data symbols before and after the data symbol from the position information of the pilot symbol. For example, if the pilot symbol is the n-th symbol, the (n−1)-th data symbol and the (n+1)-th data symbol are extracted.

After extracting the pilot symbol and the two data symbols adjacent to the pilot symbol, the first calculator 301 calculates an initial value of the optical frequency offset based on the pilot symbol and the two data symbols. After calculating the initial value of the optical frequency offset, the first calculator 301 outputs the initial value to the calculated value selector 304. Note that the detailed process of the first calculator 301 when calculating the initial value of the optical frequency offset will be described later.

The extractor 302 extracts the pilot symbol from the received symbol string output from the AEQ 212 and outputs the pilot symbol to the second calculator 303. The extractor 302 can extract the pilot symbol by using the position information of the pilot symbol described above.

The second calculator 303 calculates a non-initial value excluding the initial value of the optical frequency offset based on the pilot symbol output from the extractor. The non-initial value corresponds to the optical frequency offset amount that has fluctuated from the optical frequency offset amount currently being compensated for. After calculating the non-initial value, the second calculator 303 outputs the calculated non-initial value to the calculated value selector 304.

The calculated value selector 304 selects either the initial value or the non-initial value, and outputs the selected initial value or the non-initial value to the adder 305. The calculated value selector 304 selects either the initial value or the non-initial value based on the control of the reception controller 250. For example, if the reception controller 250 determines that the optical frequency offset has not yet been compensated for even once by the FOC 213, the calculated value selector 304 selects the initial value. On the other hand, if the reception controller 250 determines that the optical frequency offset has been compensated for at least once by the FOC 213, the calculated value selector 304 selects the non-initial value.

The adder 305 adds either the initial value or the non-initial value selected by the calculated value selector 304 to the held value held by the holder 306 provided after the adder 305, and outputs the addition result to the holder 306. When the initial value is selected as the value output by the calculated value selector 304, the holder 306 holds a value of 0 (zero). Therefore, when the initial value is selected as the value output by the calculated value selector 304, the addition result of the adder 305 matches the initial value. The holder 306 holds the addition result as a new held value, and outputs the addition result to the integrator 307. The held value is updated every time an initial value or a non-initial value is output. When the initial value is selected as the value output by the calculated value selector 304, the adder 305 may perform control so as to output the initial value output from the calculated value selector 304 without adding the held value held by the holder 306.

The integrator 307 adds the held value output from the holder 306 to the output value of the integrator 307 for each symbol, integrates, and outputs the result as the optical frequency offset compensation value 308. That is, the output value of the integrator 307 corresponds to the sum of the previous optical frequency offset compensation value 308 and the held value.

The multiplier 309 compensates for the optical frequency offset by multiplying the received symbol string output from the AEQ 212 by the optical frequency offset compensation value 308 output from the integrator 307, and outputs the result to the CPR 214. In this way, the FOC 213 compensates for the received symbol string using the optical frequency offset value calculated based on the initial value and non-initial value of the optical frequency offset.

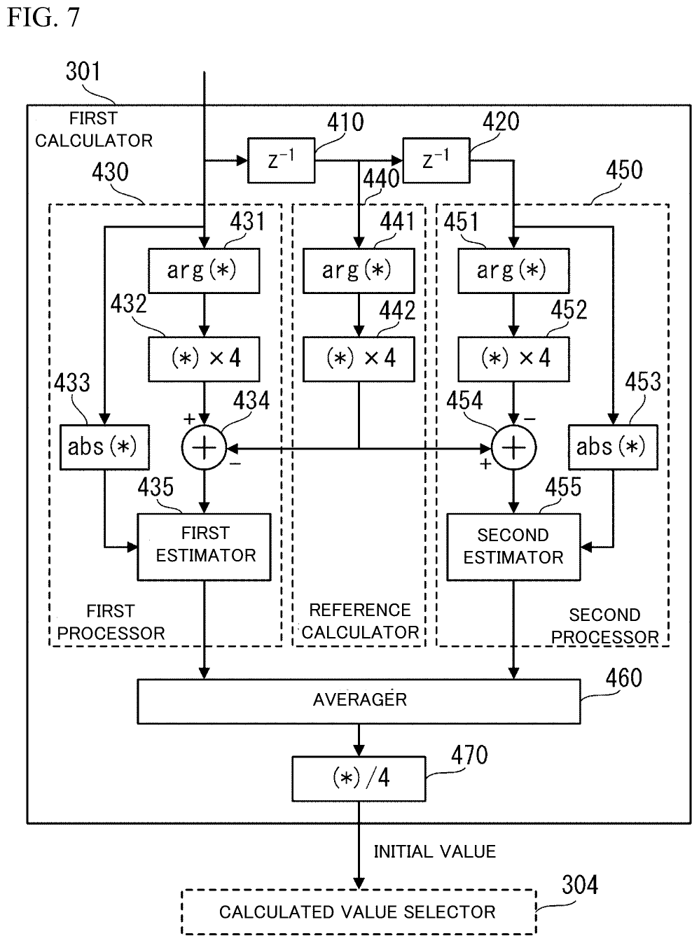

The details of the first calculator 301 will be described with reference to FIGS. 7 to 13.

The first calculator 301 has a first delayer 410, a second delayer 420, a first processor 430, a reference calculator 440, a second processor 450, an averager 460, and a divider 470. The reference calculator 440 is an example of a first angle calculator. The first processor 430 and the second processor 450 are examples of a second angle calculator. The divider 470 is an example of a calculator that calculates an initial value of the optical frequency offset by dividing the amount of optical frequency offset estimated by the first processor 430 and the second processor 450 by four.

The first delayer 410 delays the input object by one symbol and outputs the input object. The second delayer 420 delays the input object by one symbol and outputs the input object. For example, suppose that the n-th pilot symbol and two adjacent data symbols, the (n−1)-th and (n+1)-th symbols before and after the pilot symbol, are input to the first calculator 301. In this case, the first processor 430 receives the (n+1)-th data symbol adjacent to and following the n-th pilot symbol. The reference calculator 440 receives the n-th pilot symbol. The second processor 450 receives the (n−1)-th data symbol adjacent to and preceding the n-th pilot symbol.

The first processor 430 has a phase angle calculator 431, a quadrupler 432, an amplitude calculator 433, an adder 434, and a first estimator 435. The reference calculator 440 has a phase angle calculator 441 and a quadrupler 442. The second processor 450 has a phase angle calculator 451, a quadrupler 452, an amplitude calculator 453, an adder 454, and a second estimator 455. The first estimator 435 and the second estimator 455 are examples of an estimator that estimates the amount of optical frequency offset.

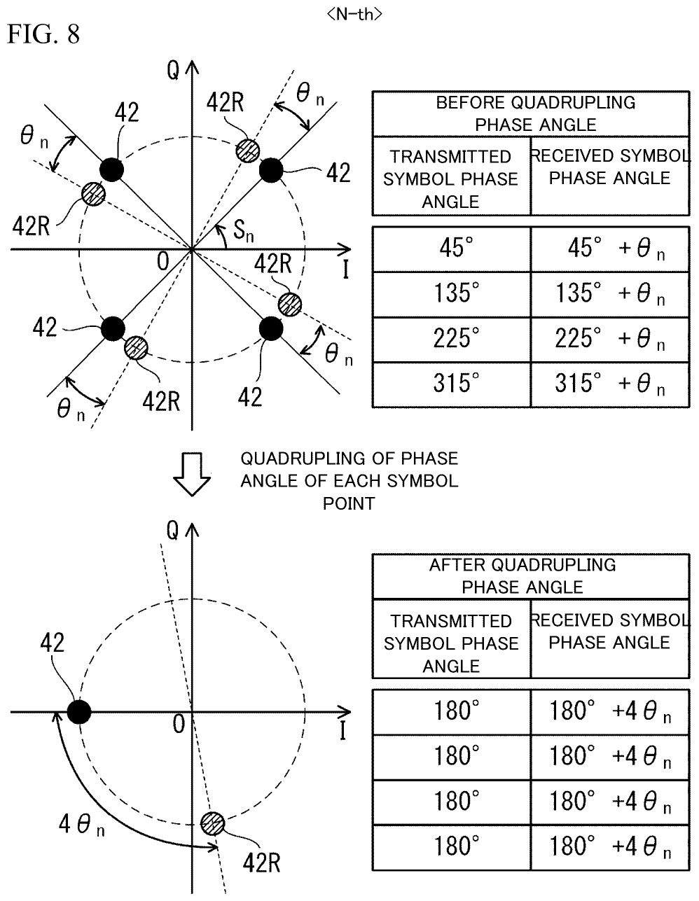

The reference calculator 440 will now be described. The phase angle calculator 441 calculates the phase angle of the n-th pilot symbol. For example, as illustrated in the upper part of FIG. 8, the phase angle difference between the phase angle of the n-th pilot symbol 42 at the time of transmission and the phase angle of the n-th pilot symbol 42R at the time of reception is θₙ. The n-th pilot symbol 42R is received at a position rotated by θₙ to the phase angle of the n-th pilot symbol 42 at the time of transmission. The phase angle calculator 441 calculates the phase angle of the pilot symbol 42R and transmits the phase angle to the quadrupler 442.

The pilot symbol 42 is modulated based on the QPSK modulation method. For example, in the first quadrant, the phase angle Sₙ of the n-th pilot symbol 42 (described as the transmission symbol in FIG. 8) is uniquely specified as 45 degrees. As with the first quadrant, the second quadrant, third quadrant, and fourth quadrant are also uniquely specified as 135 degrees, 225 degrees, and 315 degrees, respectively.

The quadrupler 442 performs a quadruple calculation on the output of the phase angle calculator 441. An explanation will be given with reference to FIG. 8. As illustrated in the upper part of FIG. 8, the pilot symbol 42R at the time of reception is a signal rotated by 0 from the pilot symbol 42 at the time of transmission. As illustrated in the lower part of FIG. 8, when a quadruple calculation is performed on the phase angle of the pilot symbol 42 at the time of transmission, the phase angles of all four pilot symbols 42 converge to 180 degrees, regardless of where the pilot symbol 42 at the time of transmission is mapped in the first to fourth quadrants. Similarly, when a quadruple calculation is performed on the phase angle of the pilot symbol 42R at the time of reception, the phase angle of the pilot symbol 42R at the time of transmission converges to a phase angle rotated by 4θ from 180 degrees, regardless of where the pilot symbol 42 at the time of transmission is mapped in the first to fourth quadrants. As a result, the quadrupler 442 outputs a phase angle of 180 degrees+4θ, which is rotated by 4θ from 180 degrees, as the first phase angle to the adders 434 and 454.

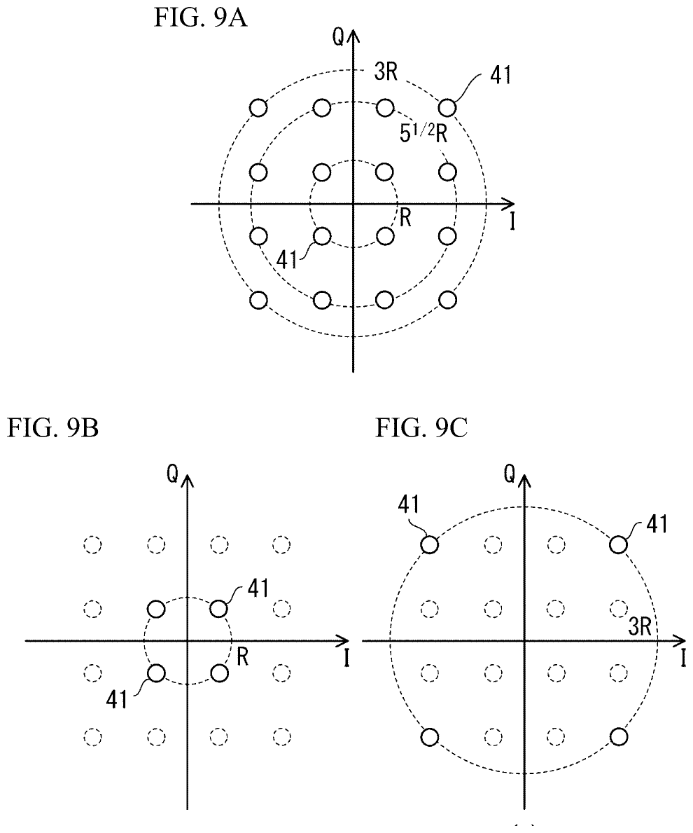

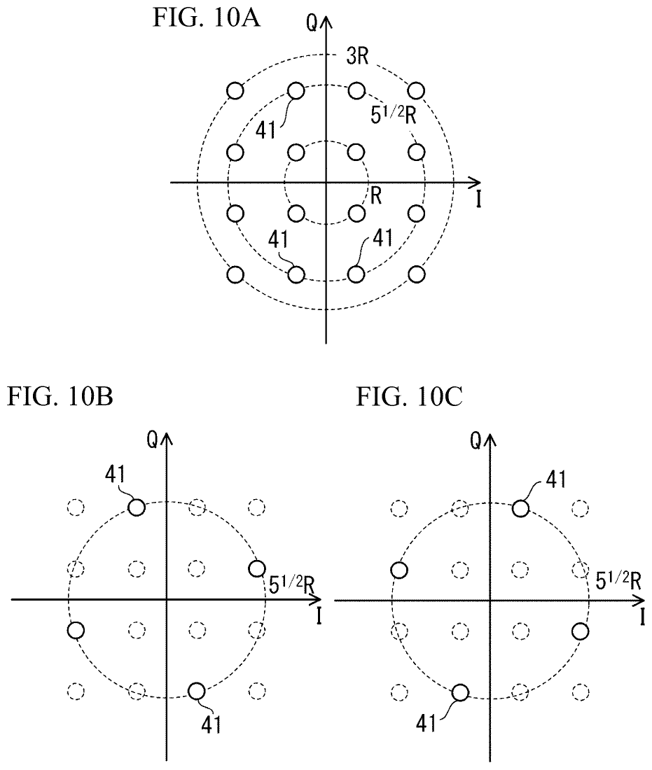

The first processor 430 will now be described. The phase angle calculator 431 calculates the phase angle of the (n+1)-th received data symbol and outputs the phase angle to the quadrupler 432. The quadrupler 432 receives the (n+1)-th received data symbol from the phase angle calculator 431, performs a quadruple operation, and outputs the result to the adder 434. For example, it is assumed that the data symbol 41 is modulated based on the 16QAM modulation method. Specifically, as illustrated in FIG. 9A and FIG. 10A, the data symbol 41 is mapped to 16 symbol points on the constellation. As illustrated in FIGS. 9A and 10A, the 16 symbol points of 16QAM can be classified into three types (amplitude Ra=radius R, radius 3R, radius √5R) according to the magnitude of the amplitude.

Each classification will be explained.

The symbol points (symbol points of the first constellation) arranged on a circumference of amplitude Ra=radius R will be explained. The symbol points of the first constellation can be expressed as symbol points mapped to four data symbols 41 on a circumference of amplitude Ra=radius R, as illustrated in FIG. 9B. The radius R is the unit radius. The symbol points of the first constellation have the same phase angle as the symbol points of the pilot symbol obtained by modulating the four data symbols 41 based on the QPSK modulation method.

The symbol points (symbol points of the second constellation) arranged on a circumference of amplitude Ra=radius 3R will be explained. As illustrated in FIG. 9C, the symbol points of the second constellation can be represented by symbol points in which four data symbols 41 are mapped on a circumference of a circle with an amplitude Ra=radius 3R. Specifically, like the first constellation, the symbol points of the second constellation have the same phase angle as the symbol points of pilot symbols in which the four data symbols 41 are modulated based on the QPSK modulation method.

The following is an explanation of the symbol points arranged on a circumference with amplitude Ra=√5R. The symbol points arranged on amplitude Ra=√5R can be classified into FIG. 10B and FIG. 10C according to the convergence point after four times the phase angle.

The symbol points in FIG. 10B arranged on a circumference with amplitude Ra=√5R (symbol points of the third constellation) can be represented as symbol points onto which four data symbols 41 on a circumference with amplitude Ra=radius 5^{1/2}R (√5R) are mapped. The symbol points of the third constellation have a different phase angle from the symbol points of the pilot symbols, which are the four data symbols 41 modulated based on the QPSK modulation method during transmission.

The symbol points in FIG. 10C (symbol points of the fourth constellation) arranged on a circumference of amplitude Ra=\sqrt{5R} can be expressed as symbol points with four data symbols 41 mapped on a circumference of amplitude Ra=radius 5^{1/2}R. Like the symbol points of the third constellation, the symbols of the fourth constellation have a different phase angle from the symbol points of pilot symbols obtained by modulating the four data symbols 41 based on the QPSK modulation method at the time of transmission.

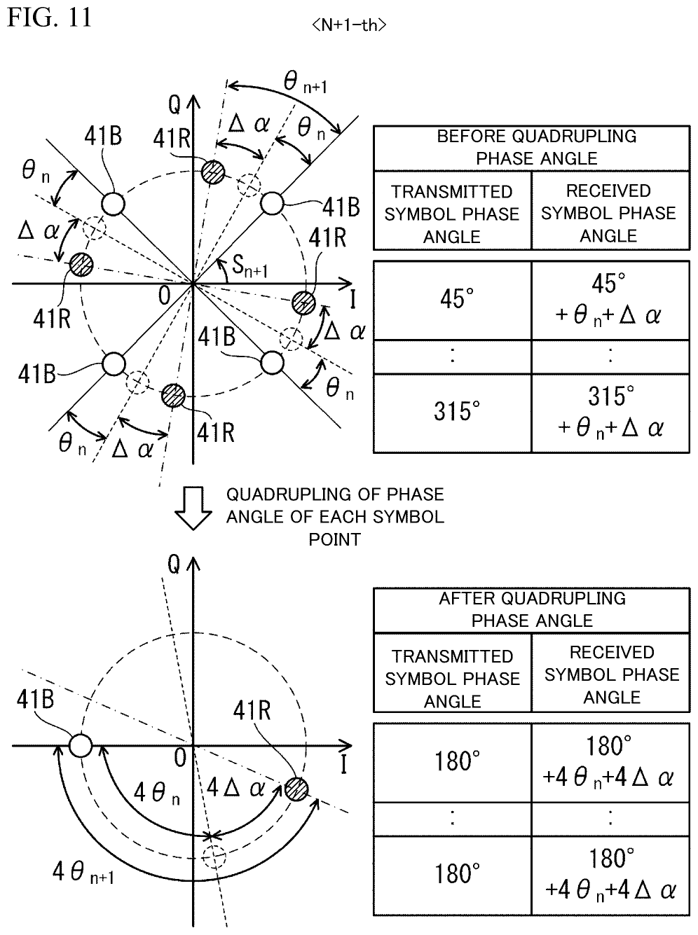

The symbol points of the first and second constellations have the same phase angle as the symbol points of pilot symbols modulated based on the QPSK modulation method. Therefore, when a calculation is performed four times the phase angle, the phase angles of all four data symbols 41 converge to 180 degrees. For example, as illustrated in the upper part of FIG. 11, if the phase angle Sₙ₊₁ at the time of transmission of the (n+1)-th data symbol 41B is 45 degrees, then, similar to the pilot symbol 42 illustrated in the lower part of FIG. 8, the phase angle of the (n+1)-th data symbol 41B after the phase angle is multiplied by four will converge to 180 degrees, as illustrated in the lower part of FIG. 11.

The symbols of the third constellation and the fourth constellation have different phase angles from the symbol points of the pilot symbols modulated based on the QPSK modulation method. Therefore, when a quadruple calculation of the phase angle is performed, none of the phase angles of the four data symbols 41 illustrated in FIG. 10B and FIG. 10C converge to 180 degrees.

In this way, the symbol points of the first constellation illustrated in FIG. 9B and the second constellation illustrated in FIG. 9C can be treated in the same way as the pilot symbol 42 modulated based on the QPSK modulation method. However, the symbol points of the third constellation illustrated in FIG. 10B and the fourth constellation illustrated in FIG. 10C cannot be treated in the same way as the pilot symbol 42 modulated based on the QPSK modulation method.

The case of a (n+1)-th received data symbol 41R will be explained. For example, the phase angle of the (n+1)-th received data symbol 41R is assumed to have rotated by a phase angle θₙ₊₁ from the (n+1)-th data symbol 41B transmitted. In that case, the phase angle of the (n+1)-th data symbol 41R can be expressed as the phase angle of the (n+1)-th data symbol 41B +θₙ₊₁. The phase angle of the (n+1)-th data symbol 41R can also be expressed as the phase angle of the (n+1)-th data symbol 41B+phase angle difference θₙ+optical frequency offset Δα.

The case will be described where the transmitted data symbol 41B corresponding to the (n+1)-th received data symbol 41R is a symbol point of the first constellation illustrated in FIG. 9B or the second constellation illustrated in FIG. 9C.

When a quadruple calculation of the symbol point included in the first constellation or the second constellation is performed, the phase angle of the (n+1)-th data symbol 41R converges to 180 degrees+4θₙ₊₁, as illustrated in the lower part of FIG. 11. Therefore, 180 degrees+4θₙ₊₁, which is the phase angle four times the phase angle of the (n+1)-th data symbol 41R, can also be expressed as 180 degrees+4θₙ+4Δα.

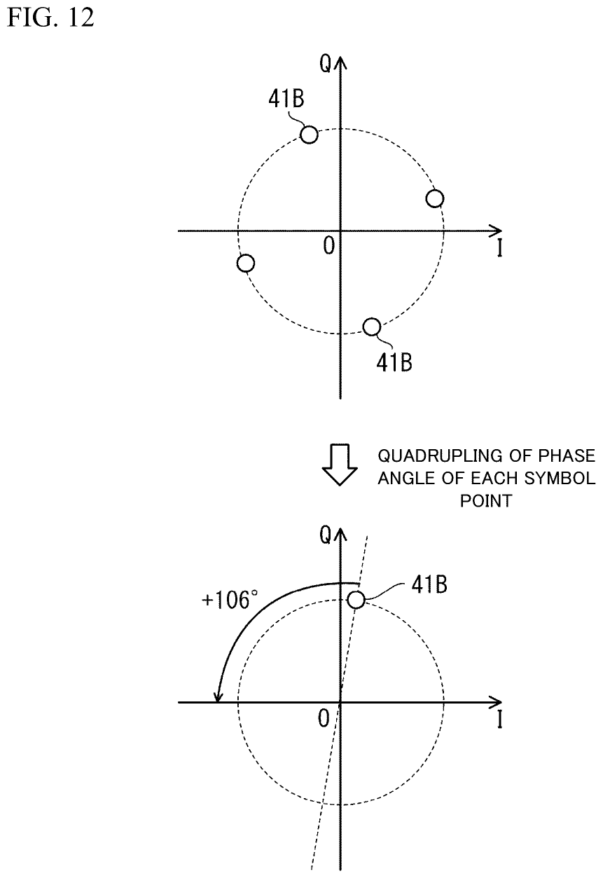

We will explain the case where the transmitted data symbol 41B corresponding to the (n+1)-th data symbol 41R is the symbol point of the third constellation illustrated in the upper part of FIG. 12.

When the phase angle is multiplied by four for the symbol points of the third constellation illustrated in the upper part of FIG. 12, the arrangement of data symbols 41B illustrated in the lower part of FIG. 12 is obtained. Therefore, the phase angle after the quadruple calculation is 74 degrees. This is different from the phase angle obtained by multiplying the phase angle of the symbol points of the first constellation and the second constellation illustrated in the lower part of FIG. 11 by four. Therefore, the phase angle obtained by multiplying the phase angle of the (n+1)-th data symbol 41R by four can be expressed as 74 degrees+4θₙ₊₁. The phase angle obtained by multiplying the phase angle of the (n+1)-th data symbol 41R by four can also be expressed as 74 degrees+4θₙ+4Δα. If a phase angle of 106 degrees is added to the phase angle obtained by multiplying the phase angle of the (n+1)-th data symbol 41R by four, the result is 180 degrees+4θₙ+4Δα.

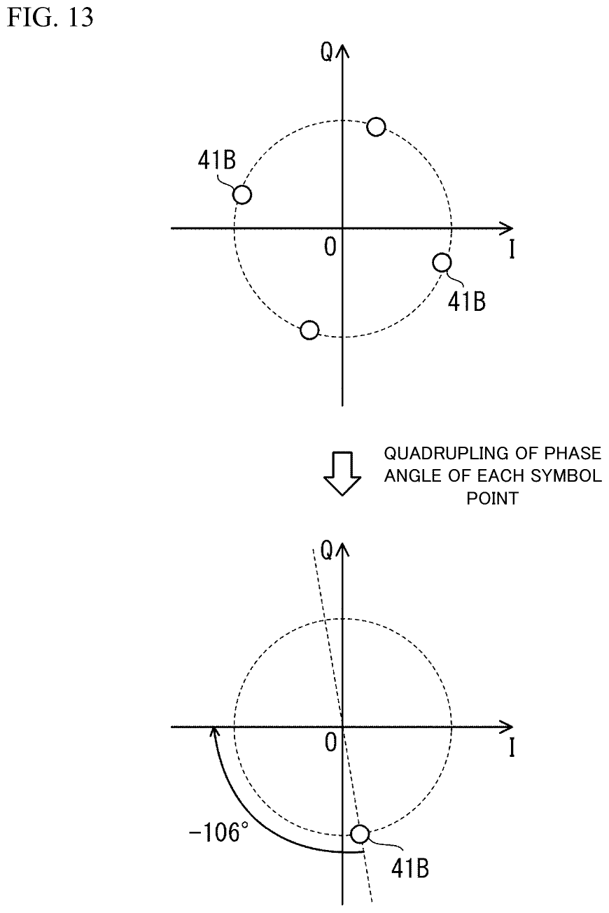

The case where the transmitted data symbol 41B corresponding to the (n+1)-th data symbol 41R is at the symbol point of the fourth constellation illustrated in the upper part of FIG. 13 will be described.

When a quadruple operation is performed on the symbol point of the fourth constellation illustrated in the upper part of FIG. 13, the arrangement of data symbols 41B illustrated in the lower part of FIG. 13 is obtained. Therefore, the phase angle after the quadruple operation is 286 degrees. This is different from the phase angle result obtained by performing a quadruple operation on the phase angle of the symbol point of the first constellation or the second constellation illustrated in the lower part of FIG. 11. Therefore, the phase angle obtained by performing a quadruple operation on the phase angle of the (n+1)-th data symbol 41R can be expressed as 286 degrees+4θₙ₊₁. The phase angle obtained by performing a quadruple operation on the phase angle of the (n+1)-th data symbol 41R can also be expressed as 286 degrees+4θₙ+4Δα. If a phase angle of 106 degrees is subtracted from the phase angle of the (n+1)-th data symbol 41R multiplied by four, the result is 180 degrees+4θₙ+4Δα.

Details will be described later, but the first estimator 435 subtracts 106 degrees from the phase angle of the output of the quadrupler 432 in the case of the third constellation and adds 106 degrees in the case of the fourth constellation, thereby calculating the optical frequency offset in the same manner as in the case of the first and second constellations. In the case of the first and second constellations, the first estimator 435 avoids such an angle correction of 106 degrees. The first estimator 435 determines whether the transmitted data symbol 41B corresponding to the (n+1)-th received data symbol 41R corresponds to the first constellation, the second constellation, the third constellation, or the fourth constellation, and performs angle adjustment on the phase angle calculated from the received data symbol.

Returning to the explanation of the adder 434, the adder 434 subtracts the first phase angle output from the quadrupler 442 from the second phase angle output from the quadrupler 432, and inputs the result to the first estimator 435. Below, we will explain the cases where the transmitted data symbol 41B corresponding to the (n+1)-th received data symbol 41R input to the adder 434 is a symbol point of the first constellation, the second constellation, the third constellation, and the fourth constellation.

The case where the transmitted data symbol 41B is a symbol point of the first or second constellation will be described. The quadrupler 442 outputs 180 degrees+4θₙ as the first phase angle. The second phase angle output by the quadrupler 432 is 180 degrees+4θₙ+4Δα, so when the difference from the first phase angle is calculated, the adder 434 outputs a value of 4Δα.

The case where the transmitted data symbol 41B is a symbol point of the third constellation will be described. The quadrupler 442 outputs 180 degrees+4θₙ as the first phase angle. The second phase angle output by the quadrupler 432 is 72 degrees+4θₙ+4Δα, so when the difference from the first phase angle is calculated, the adder 434 outputs a value corresponding to −106 degrees+4Δα. Therefore, by adding a phase angle of 106 degrees to the output result of the adder 434, it is possible to calculate the same value of 4Δα as when the transmitted data symbol 41B is a symbol point of the first or second constellation.

The case where the transmitted data symbol 41B is a symbol of the fourth constellation will be described. The quadrupler 442 outputs 180 degrees+4θₙ as the first phase angle. Since the second phase angle output from the quadrupler 432 is 286 degrees+4θₙ+4Δα, when the difference from the first phase angle is calculated, the adder 434 outputs a value corresponding to 106 degrees+4Δα. Therefore, by subtracting a phase angle of 106 degrees from the output result of the adder 434, it is possible to calculate a value corresponding to 4Δα as when the transmitted data symbol 41B is a symbol point of the first or second constellation.

From the above, if it can be estimated whether the (n+1)-th transmitted data symbol 41B corresponds to a symbol point of the first constellation, the second constellation, the third constellation, or the fourth constellation, then by applying a correction to the output value of the adder 434, it is possible to calculate the optical frequency offset 4Δα multiplied by four, which is the same as when the transmitted data symbol 41B is a symbol point of the first constellation or the second constellation.

On the other hand, the amplitude calculator 433 calculates the amplitude Ra (specifically, the absolute value of the amplitude Ra) of the (n+1)-th data symbol 41R, and outputs the calculated amplitude Ra to the first estimator 435. The first estimator 435 estimates the optical frequency offset multiplied by four based on the value output from the adder 434 and the amplitude Ra output from the amplitude calculator 433. The first estimator 435 then outputs the estimated optical frequency offset to the averager 460.

The second processor 450 will now be described. The second processor 450 basically executes the same processing as the first processor 430 for the (n−1)-th data symbol 41A (sec FIG. 2). The difference is that the adder 434 of the first processor 430 inverts the sign of the first phase angle, but the adder 454 of the second processor 450 does not invert the sign of the first phase angle. The adder 454 inverts the sign of the second phase angle output from the quadrupler 452 and adds the second phase angle and the first phase angle. As a result, the adder 454 calculates the difference between the second phase angle and the first phase angle, and inputs the calculated value to the second estimator 455. The second estimator 455 calculates the optical frequency offset multiplied by four in the same way as the first estimator, and outputs the calculated value to the averager 460.

The averager 460 calculates the average value of the optical frequency offset output from the first estimator 435 and the optical frequency offset output from the second estimator 455, and outputs the average value to the divider 470. The divider 470 calculates an initial value of the optical frequency offset by dividing the average value output from the averager 460 by four. After calculating the initial value, the divider 470 outputs the initial value to the calculation value selector 304.

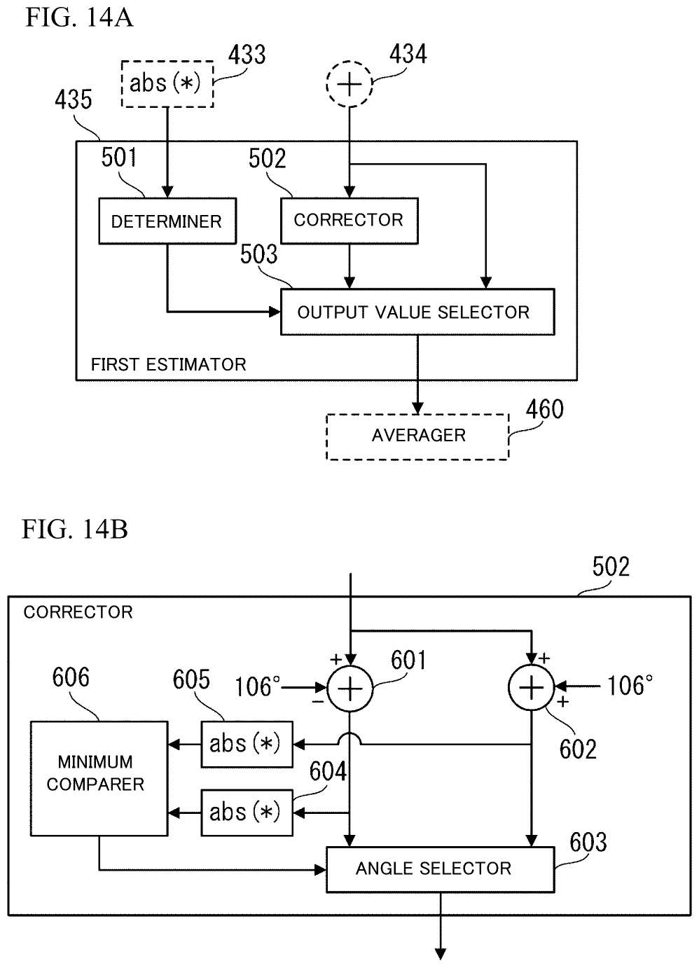

The first estimator 435 will be described with reference to FIG. 14A. Note that the second estimator 455 is basically the same as the first estimator 435, so a detailed description will be omitted. The first estimator 435 has a determiner 501, a corrector 502, and an output value selector 503.

The determiner 501 determines the area on the constellation that contains the (n+1)-th data symbol 41R, based on the magnitude of the amplitude Ra output from the amplitude calculator 433.

For example, if amplitude Ra<(R+5^{1/2}R)/2 is satisfied, the determiner 501 determines that the (n+1)-th data symbol 41R is included in a first region. The first region is the region inside a virtual first circle that is virtually located halfway between a first circle of radius R and a second circle of radius 5^{1/2}R. In this case, the transmitted data symbol 41B that corresponds to the (n+1)-th data symbol 41R is determined to be on radius R, and is therefore included in the first constellation described above.

If (5^{1/2}R+3R)/2<amplitude Ra is satisfied, the determiner 501 determines that the (n+1)-th data symbol 41R is included in a third region. The third region is a region outside a virtual second circle that is virtually located halfway between the second circle of radius 5^{1/2}R and the third circle of radius 3R. In this case, the transmitted data symbol 41B corresponding to the (n+1)-th data symbol 41R is determined to be on the radius 3R, and is therefore included in the second constellation described above.

If (R+5^{1/2}R)/2<amplitude Ra<(5^{1/2}R+3R)/2 is satisfied, the determiner 501 determines that the (n+1)-th data symbol 41R is included in a second region. The second region is a region outside the virtual first circle and inside the virtual second circle. In this case, the transmission data symbol 41B corresponding to the (n+1)-th data symbol 41R is determined to be on a radius of 5^{1/2}R, and is therefore included in the third or fourth constellation described above.

The corrector 502 uses the value of the (n+1)-th data symbol 41R output from the adder 434 to determine whether the transmitted data symbol 41B corresponding to the (n+1)-th data symbol 41R is included in the third or fourth constellation. Thereafter, the corrector 502 calculates a value based on the determination result. The method of determining whether the transmitted data symbol 41B is included in the third or fourth constellation will be described later.

The output value selector 503 outputs either the output value of the adder 434 or the output value of the corrector 502 based on the determination result output from the determiner 501. For example, if the determiner 501 outputs a determination result indicating that amplitude Ra of transmitted data symbol 41B corresponds to radius R or radius 3R, the output value selector 503 selects the output value of the adder 434. On the other hand, if the determiner 501 outputs a determination result indicating that amplitude Ra of transmitted data symbol 41B corresponds to radius 5^{1/2}R, the output value selector 503 selects the output value of the corrector 502.

With reference to FIG. 14B, the corrector 502 will be described. The corrector 502 has a first adder 601, a second adder 602, an angle selector 603, a first absolute value calculator 604, a second absolute value calculator 605, and a minimum comparer 606.

The first adder 601 inverts the sign of 106 degrees and adds −106 degrees to the phase angle of the input object. In other words, the first adder 601 subtracts 106 degrees from the phase angle of the input object. Either −106 degrees+4Δα or 106 degrees+4Δα is input to the corrector 502. For example, when −106 degrees+4Δα is input, the first adder 601 subtracts 106 degrees from −106 degrees+4Δα and outputs the subtraction result, −212 degrees+4Δα, to the angle selector 603 and the first absolute value calculator 604. When 106 degrees +4Δα is input, the first adder 601 subtracts 106 degrees from 106 degrees+4Δα and outputs the subtraction result, 4Δα, to the angle selector 603 and the first absolute value calculator 604.

The second adder 602 adds 106 degrees to the phase angle of the input object without inverting the sign of 106 degrees. That is, the second adder 602 adds 106 degrees to the phase angle of the input object. As described above, either −106 degrees+4Δα or 106 degrees+4Δα is input to the corrector 502. For example, when −106 degrees+4Δα is input, the second adder 602 adds 106 degrees to −106 degrees+4Δα and outputs the addition result, 4Δα, to the angle selector 603 and the second absolute value calculator 605. When 106 degrees+4Δα is input, the second adder 602 adds 106 degrees to 106 degrees+4Δα and outputs the addition result, 212 degrees+4Δα, to the angle selector 603 and the second absolute value calculator 605.

The first absolute value calculator 604 calculates the absolute value of the output value of the first adder 601 and outputs the calculated value to the minimum comparer 606. The second absolute value calculator 605 calculates the absolute value of the output value of the second adder 602 and outputs the calculated value to the minimum comparer 606. The minimum comparer 606 compares the absolute value of the output value of the first adder 601 with the absolute value of the output value of the second adder 602, and notifies the angle selector 603 of the output value of the first adder 601 or the output value of the second adder 602 which has a smaller absolute value. Based on the notification from the minimum comparer 606, the angle selector 603 selects the output value of the first adder 601 or the output value of the second adder 602. As a result, the angle selector 603 outputs the output value of the first adder 601 or the output value of the second adder 602 which is closer to the first phase angle.

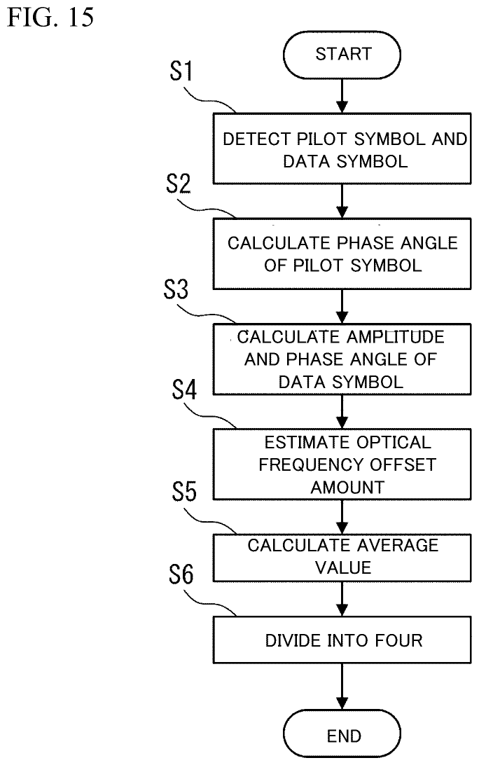

The operation of the first calculator 301 will be described with reference to FIG. 15.

The first calculator 301 first detects a pilot symbol and adjacent data symbols before and after the pilot symbol (step S1). Specifically, the first calculator 301 detects a pilot symbol and adjacent data symbols before and after the pilot symbol based on position information of the pilot symbol 42 identified by a synchronizer (not illustrated) provided between the CDC 211 and the AEQ 212 or after the AEQ 212.

The first calculator 301 uses the detected pilot symbol to calculate the first phase angle in the reference calculator 440 (step S2). Specifically, the phase angle calculator 441 and the quadrupler 442 work together to quadruple the phase angle of the pilot symbol to calculate 180 degrees+4θas the first phase angle. After the reference calculator 440 calculates the first phase angle, the first processor 430 and the second processor 450 each calculate the amplitude and the phase angle using the detected data symbol (step S3).

The amplitude calculator 433 and 453 calculate the amplitude of the adjacent data symbols before and after the pilot symbol. The phase angle calculator 431 and the quadrupler 432 work together to calculate the second phase angle by quadrupling the phase angle of the adjacent data symbol after the pilot symbol. Similarly, the second processor 450, in cooperation with the phase angle calculator 451 and the quadrupler 452, calculates a second phase angle that is four times the phase angle of the data symbol adjacent to the pilot symbol.

Using the amplitude of the data symbol calculated by the amplitude calculators 433 and 453 and the second phase angle calculated by the first processor 430 and the second processor 450, the first estimator 435 and the second estimator 455 estimate the optical frequency offset amount multiplied by four (step S4).

The averager 460 calculates the average value of the optical frequency offset from the estimated amount of the optical frequency offset by the first estimator 435 and the second estimator 455 (step S5). The divider 470 divides the average value calculated by the averager 460 by four (step S6). Specifically, the divider 470 divides the average value by four to calculate the initial value of the optical frequency offset. Once the divider 470 has calculated the initial value, the first processor 430 and the second processor 450 end their processing.

In this way, the optical receiver 20 of this embodiment calculates the initial value of the optical frequency offset based on the pilot symbol and the data symbols adjacent before and after the pilot symbol, and compensates for the optical frequency offset based on the calculated initial value. For example, if the initial value of the optical frequency offset were calculated based on all data symbols regardless of the pilot symbol, the amount of calculation required to calculate the initial value would increase, making it difficult to calculate the initial value quickly.

If, for example, the calculation circuits for calculating the initial values are parallelized in order to calculate the initial values at high speed, the circuit scale increases because a calculation circuit according to the number of parallel circuits is required. The increase in circuit scale leads to an increase in electrical power consumption when calculating the initial value of the optical frequency offset. However, the optical receiver 20 according to this embodiment calculates the initial value of the optical frequency offset based on the pilot symbol and the data symbols adjacent to the pilot symbol, so the circuit scale and the electrical power consumption are reduced.

### Second Embodiment

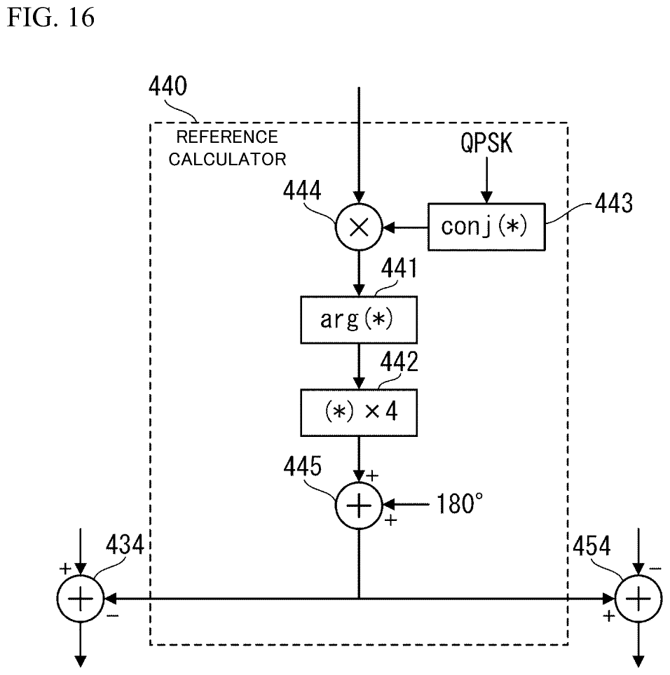

Next, the second embodiment of this case will be described with reference to FIG. 16 to FIG. 18. As illustrated in FIG. 16, the reference calculator 440 according to the second embodiment differs from the reference calculator 440 according to the first embodiment in that the reference calculator 440 further includes a conjugator 443, a multiplier 444, and an adder 445.

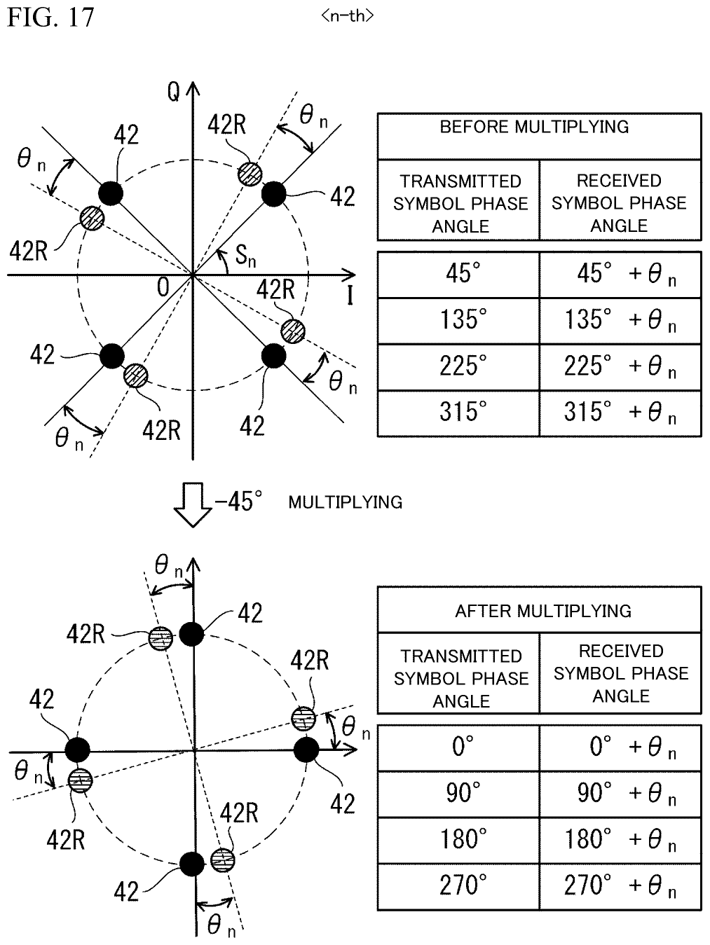

For example, when 45 degrees in QPSK is input to the conjugator 443, the conjugator 443 inverts the sign and outputs −45 degrees to the multiplier 444. As a result, when the n-th pilot symbol is input, the multiplier 444 multiplies the n-th pilot symbol by −45 degrees and outputs the result to the phase angle calculator 441. As a result, as illustrated in FIG. 17, an n-th pilot symbol 42R at the time of reception is mapped to a position rotated by −45 degrees.

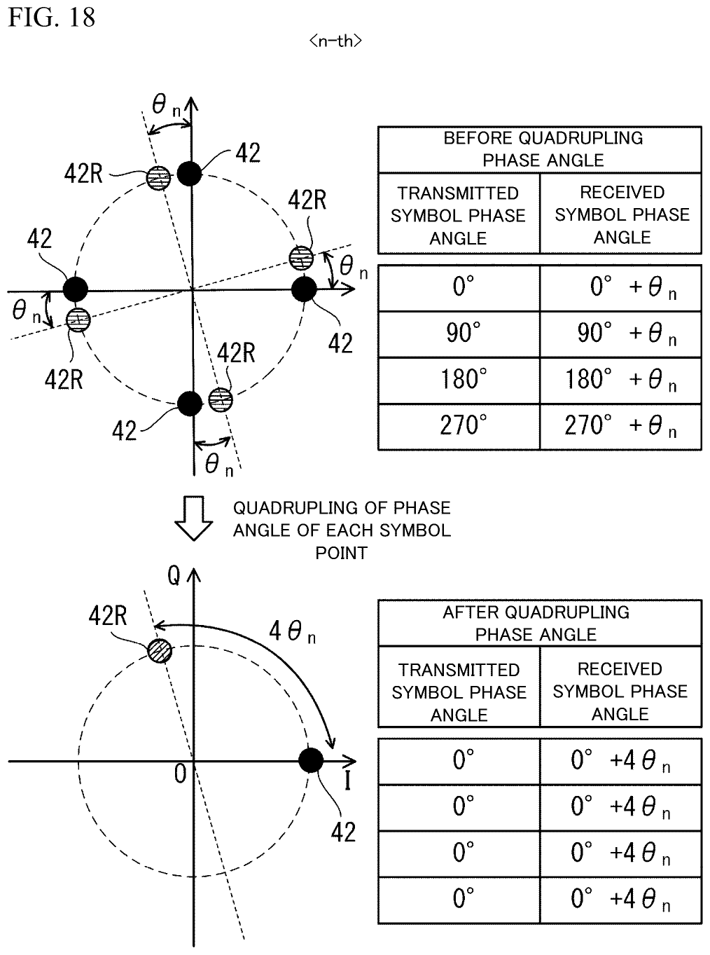

The phase angle calculator 441 calculates the phase angle difference On from the n-th pilot symbol 42 at the time of transmission based on the relationship with the n-th pilot symbol 42 at the time of transmission. The quadrupler 442 performs a quadruple operation on the phase angle difference On calculated by the phase angle calculator 441. As a result, as illustrated in FIG. 18, no matter where the n-th pilot symbol 42 at the time of transmission is mapped in the first quadrant to the fourth quadrant, the phase angle of the pilot symbol 42R all converges to a phase angle rotated by 4θ, from 0 degrees.

The adder 445 adds 180 degrees to the phase angle output from the quadrupler 442. As a result, similar to the first embodiment, the reference calculator 440 calculates the first phase angle (see the lower part of FIG. 8). In this way, even if the optical receiver 20 includes the reference calculator 440 according to the second embodiment, the circuit size and the electrical power consumption are reduced similar to the first embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An optical receiver comprising:
a receiver configured to receive an optical signal that includes a plurality of data symbols and pilot symbols periodically inserted between the plurality of data symbols and that is modulated based on a multi-level modulation method;
a first angle calculator configured to calculate a first phase angle to be used for calculating an initial value when compensating for an optical frequency offset, based on the pilot symbols;
a second angle calculator configured to calculate a second phase angle of the plurality of data symbols based on a data symbol adjacent to the pilot symbol among the plurality of data symbols;
an estimator configured to estimate an amount of the optical frequency offset based on a differential phase angle between the first phase angle and the second phase angle and amplitude of the data symbol; and
a compensator configured to compensate for the optical frequency offset based on the amount of the optical frequency offset.

2. The optical receiver as claimed in claim 1, further comprising:
a calculator configured to calculate the initial value by dividing the amount of the optical frequency offset by four,
wherein the compensator compensates for the optical frequency offset based on the initial value.

3. The optical receiver as claimed in claim 1,
wherein the estimator determines an area in which the amplitude of the data symbol is included based on a magnitude of the amplitude, and determines whether or not to perform an angle correction of 106 degrees on the differential phase angle based on a determination result.

4. The optical receiver as claimed in claim 1,
wherein the estimator determines an area in which the amplitude of the data symbol is included based on a magnitude of the amplitude, and performs an angle correction of 106 degrees on the differential phase angle when the data symbol is included in an area outside half of a sum of a unit radius and 5^{1/2} times the unit radius and inside half of the sum of 5^{1/2} times the unit radius and 3 times the unit radius.

5. The optical receiver as claimed in claim 1,
wherein the estimator determines an area in which the amplitude of the data symbol is included based on a magnitude of the amplitude, and avoids angle correction for the differential phase angle when the data symbol is included in an arca inside half of a sum of a unit radius and 5^{1/2} times the unit radius, and when the data symbol is included in an area between an area outside half of the sum of 5^{1/2} times the unit radius and 3 times the unit radius.

6. The optical receiver as claimed in claim 3,
wherein the estimator performs a first angle correction of subtracting 106 degrees from the differential phase angle and a second angle correction of adding 106 degrees to the differential phase angle, and selects one of the differential phase angle after performing the first angle correction and the differential phase angle after performing the second angle correction, which has a smaller absolute value after correction.

7. The optical receiver as claimed in claim 2,
wherein the second angle calculator calculates a first specific phase angle of a first data symbol adjacent to and before the pilot symbol among the plurality of data symbols, based on the first data symbol, and calculates a second specific phase angle of a second data symbol adjacent to and after the pilot symbol among the plurality of data symbols, based on the second data symbol,
wherein the estimator estimates an amount of a first optical frequency offset based on a first differential phase angle between the first phase angle and the first specific phase angle and a first amplitude of the first data symbol, and estimates an amount of a second optical frequency offset based on a second differential phase angle between the first phase angle and the second specific phase angle and a second amplitude of the second data symbol, and
wherein the calculator calculates the initial value by dividing an average value of the amount of the first optical frequency offset and the amount of the second optical frequency offset by four.

8. The optical receiver as claimed in claim 2,
wherein the second angle calculator calculates a first specific phase angle of a first data symbol adjacent to and preceding the pilot symbol among the multiple data symbols, based on the first data symbol,
wherein the estimator estimates an amount of a first optical frequency offset based on a first differential phase angle between the first phase angle and the first specific phase angle and a first amplitude of the first data symbol, and
wherein the calculator calculates the initial value by dividing the average value of the amount of the first optical frequency offset by four.

9. The optical receiver as claimed in claim 2,
wherein the second angle calculator calculates a second specific phase angle of a second data symbol adjacent to the pilot symbol among the multiple data symbols, based on the second data symbol,
wherein the estimator estimates an amount of a second optical frequency offset based on a second differential phase angle between the first phase angle and the second specific phase angle and a second amplitude of the second data symbol, and
wherein the calculator calculates the initial value by dividing the average value of the amount of the second optical frequency offset by four.

10. The optical receiver as claimed in claim 1,
wherein the optical signal includes a signal including the plurality of data symbols and modulated by 16QAM (Quadrature Amplitude Modulation) belonging to the multi-level modulation method, and a signal including the pilot symbol and modulated by QPSK (Quadrature Phase Shift Keying) belonging to the multi-level modulation method.

11. An optical receiving method comprising:
receiving an optical signal that includes a plurality of data symbols and pilot symbols periodically inserted between the plurality of data symbols and that is modulated based on a multi-level modulation method;
calculating a first phase angle to be used for calculating an initial value when compensating for an optical frequency offset, based on the pilot symbol;
calculating a second phase angle of a data symbol adjacent to the pilot symbol among the plurality of data symbols, based on the data symbol;
estimating an amount of the optical frequency offset based on a differential phase angle between the first phase angle and the second phase angle and amplitude of the data symbol; and
compensating for the optical frequency offset based on the amount of the optical frequency offset.
